(19) United States
(12) Patent Application Publication
(10) Pub. No.: US 2005/0173036 A1
(43) Pub. Date: Aug. 11, 2005

(54) Motorcycle tire, especially for off-road use or as high-speed motocross tire

(76) Inventor: Eric Rossignaud, Villebret (FR)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/889,703

(22) Filed: Jul. 13, 2004

(30) Foreign Application Priority Data
Feb. 6, 2004 (IB) DM/064952
Apr. 24, 2004 (DE) 20 2004 006 512.6

(51) Int. Cl. B60C 11/11; B60C 17/02; B60C 113/00; B60C 121/00; B60C 123/00

(52) U.S. Cl. 152/209.11; 152/209.15

(57) ABSTRACT

A motorcycle tire comprising a generally toroidal-shaped surface extending between two opposite sidewalls of the tire and a plurality of blocks being arranged onto the toroidal-shaped surface is disclosed. The blocks are adapted to be ground contacting and to form an outer circumferential tread profile of the tire. At least a portion of the blocks has a cross-like structure or a T-shaped structure in topview onto the toroidal-shaped surface. The tire is made to be mounted on a trailing wheel of a motorcycle. It can be used as off-road tire or as high-speed motocross tire.

### FIELD OF THE INVENTION

The present invention is directed to a motorcycle tire. More specifically, it is directed to a motorcycle tire for off-road use or to a motocross tire, which can be used under high-speed conditions as they occur during races.

### BACKGROUND OF THE INVENTION

DE 36 28 042 A1 discloses a motorcycle tire with a tread profile which is designed for an off-road use like a motocross application. The tread profile of this tire comprises a plurality of blocks having a rectangular shape in topview onto surface of the tread.

An object of the present invention was to provide a motorcycle tire which is especially suitable for off-road use, i.e. in a terrain, on a rural road, on sand or gravel or other loose soil on a hard ground, as it is typical for motocross races or the driving in a desert, which allows a high speed at good grip to the road surface under these conditions, and which generates low or reduced vibrations under these conditions.

In more detail, it was an object of this invention to provide a motorcycle tire which is suitable as a race tire for motocross motorcycles and which is especially suitable to be mounted on the trailing wheel of such motorcycles.

### SUMMARY OF THE INVENTION

The present invention is directed to motorcycle tire comprising a generally toroidal-shaped surface extending between two opposite sidewalls of the tire, and a plurality of blocks being arranged onto the toroidal-shaped surface, wherein the blocks are adapted to be ground contacting and to form an outer circumferential tread profile of the tire, and wherein at least a portion of the blocks has a cross-like structure or a T-shaped structure in topview onto the toroidal-shaped surface.

In one aspect of the invention, at least a portion of blocks selected from the group consisting of the blocks having the T-shaped structure and the blocks having the cross-like structure is arranged on a section boundary formed by the intersection of the toroidal-shaped surface and the equatorial plane of the tire.

In another aspect of the invention, at least a portion of the T-shaped or cross-like blocks has a symmetrical structure when viewed in topview onto the toroidal-shaped surface.

In a further aspect of the invention, at least a portion of the T-shaped or-cross-like blocks is arranged in a symmetrical way on a section boundary formed by the intersection of the toroidal-shaped surface and the equatorial plane of the tire.

In a further aspect of the invention, the toroidal-shaped surface comprises a central area with a plurality of blocks being arranged within the central area, wherein the central area is circumferentially extending around the toroidal-shaped surface, and wherein all of the blocks being arranged within the central area are either T-shaped blocks or cross-like blocks.

In a further aspect of the invention, at least a portion of the T-shaped or cross-like blocks has a groove structure at its surface, wherein the depth of the grooves forming the groove structure is lower than the height of the blocks having the T-shaped or cross-like structure as measured in radial direction starting from the toroidal-shaped surface. Those grooves can be arranged in a symmetrical way with respect to a section boundary formed by the intersection of the toroidal-shaped surface and the equatorial plane of the tire.

In yet a further aspect of the invention, a plurality of first blocks with a first cross-like structure and a plurality of second blocks with a second cross-like structure differing from the first cross-like structure are arranged onto the toroidal-shaped surface, wherein said second blocks have at least two grooves at their surface, and wherein said at least two grooves are arranged in parallel to a section boundary formed by the intersection of the toroidal-shaped surface and the equatorial plane of the tire. Alternatively, a plurality of first blocks with the first T-shaped structure and a plurality of second blocks with the second T-shaped structure differing from the first T-shaped structure are arranged onto the toroidal-shaped surface, wherein said second blocks have at least two grooves at their surface, and wherein said at least two grooves are arranged in parallel to a section boundary formed by the intersection of the toroidal-shaped surface and the equatorial plane of the tire.

In yet a further aspect of the invention, the toroidal-shaped surface comprises a central area with a plurality of blocks being arranged within the central area, wherein the central area is circumferentially extending around the toroidal-shaped surface, wherein all of the blocks arranged within the central area are circumferentially extending, uniformly shaped blocks being arranged on a section boundary formed by the intersection of the toroidal-shaped surface and the equatorial plane of the tire, and wherein all of the blocks are either the blocks having the T-shaped structure or the blocks having the cross-like structure.

In a further aspect of the invention, first blocks with a first cross-like or T-shaped structure and second blocks with a second cross-like or T-shaped structure differing from the first cross-like or T-shaped structure are arranged in a circumferential way on a section boundary formed by the intersection of the toroidal-shaped surface and the equatorial plane of the tire. In the case, there is always at least one, preferably two or three, of the second blocks arranged between two sequent blocks of the first blocks.

In an other aspect of the invention, first blocks with a first cross-like or T-shaped structure and second blocks with a second cross-like or T-shaped structure differing form the first blocks' structure are provided in a circumferential way on a section boundary formed by the intersection of the toroidal-shaped surface and the equatorial plane of the tire, wherein the first blocks and the second blocks differ only in their width perpendicular to the section boundary, in the presence of a groove structure comprising at least one groove on the surface of the respective blocks, or in their width perpendicular to the section boundary and in the presence of a groove structure comprising at least one groove at the surface of the respective blocks.

In a further aspect of the invention, the T-shaped or cross-like blocks have a height of from 10 mm to 20 mm, alternatively of from 14 mm to 18 mm, as measured in radial direction starting from the toroidal-shaped surface.

In a further aspect of the invention, the T-shaped or cross-like blocks have a width as measured in perpendicular direction to a section boundary formed by the intersection of the toroidal-shaped surface and the equatorial plane of the tire of from 40 mm to 90 mm, alternatively of from 55 mm to 85 mm, and a length as measured in parallel direction to said section boundary of from 25 mm to 50 mm, alternatively of from 32 mm to 44 mm.

In yet a further aspect of the invention, the blocks selected from the group consisting of the blocks having the T-shaped structure and the blocks having the cross-like structure have a distance between each other, as measured on the toroidal-shaped surface, of from 45 mm to 75 mm, alternatively of from 50 mm to 60 mm.

The motorcycle tire according the invention has the advantage of a comparably silent and smooth run. This leads to a better grip on the road and reduced vibrations during driving the motorcycle.

Next to this, the motorcycle tire according the invention provides an increased lateral stability of the motorcycle equipped with such a tire on various road conditions. This results in an improved handling and an increased driving security. These advantages become apparent especially when driving on sand or gravel or other kinds of loose soil on a harder subsoil, which is typical when driving in a desert or for motocross races, especially under dry conditions. Under such conditions, the cross-like or a T-shaped structure of the blocks also results in a lower tread wear, which increases the lifetime or the mileage of such tires, and, often even more important, also results in a reduced heat generation in the tire. Thus, the motorcycle tire according to the invention does not tend to an overheating and/or a degradation of the materials of the tire. This is essential especially in case of very high demands on the performance of the tire, as they are typical for race tires and especially for race tires used on the trailing wheel of a race motorcycle. Thus, the motorcycle tire according to the invention is suitable as a race tire for motorcycles and designed especially for races on sand, gravel or other kinds of loose soil on a harder subsoil.

In addition to these advantages, the motorcycle tire according to the invention provide a very good long term stability under high-speed conditions and without a chunking of parts of the tread profile. This is believed to be mainly due to the increased mechanical stability of the T-shaped or cross-like structure of the blocks arranged in the central area of the tread.

### BRIEF DESCRIPTION OF THE DRAWINGS

The invention will be described by way of example and with reference to the accompanying drawings in which:

FIG. 1 is a perspective view of a first embodiment of the invention;

FIG. 2 is a side view of the tire of FIG. 1;

FIG. 3 is a section of the tread of the tire of FIG. 1 in topview onto this tire;

FIG. 4 is a perspective view of a second embodiment of the invention;

FIG. 5 is a side view of the tire of FIG. 4;

FIG. 6 is a section of the tread of the tire of FIG. 4 in topview onto this tire;

FIG. 7 is a perspective view of a third embodiment of the invention;

FIG. 8 is a side view of the tire of FIG. 7; and

FIG. 9 is a section of the tread of the tire of FIG. 7 in topview onto this tire.

### DETAILED DESCRIPTION OF THE INVENTION

The embodiments of the invention refer to pneumatic motorcycle tires having a size of 140/90 18 D908 RR, for example. Preferably, these tires are mounted on a rim on the trailing wheel of a motorcycle, more preferably a race motorcycle.

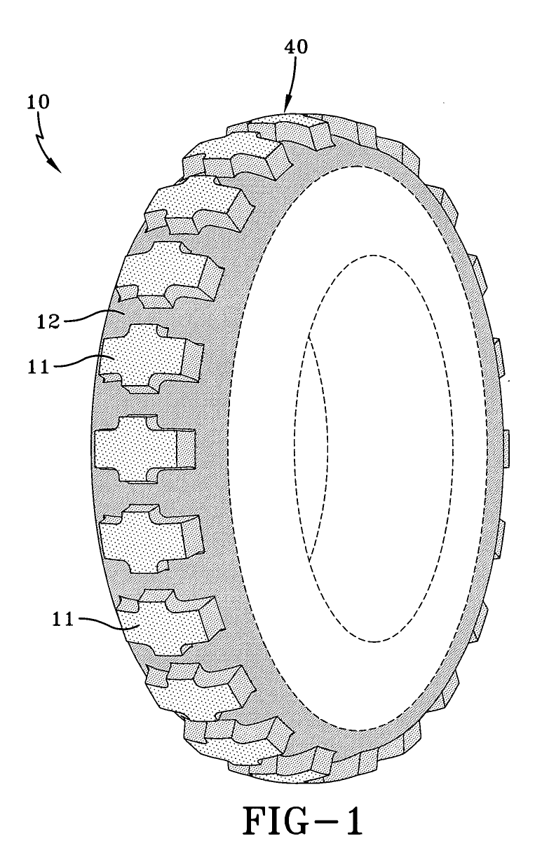

FIG. 1 shows a first embodiment of a tire 10 of a motorcycle comprising an outer toroidal-shaped surface 12 extending between two opposite sidewalls of the tire 10. Onto the toroidal-shaped surface 12, there is a plurality of blocks 11 joined to the surface 12, which are adapted to be ground contacting and to form an outer circumferential tread profile of the tire 10. The blocks 11 are arranged in a central area 40 of the toroidal-shaped surface 12 and have a cross-like structure in topview onto the toroidal-shaped surface 12. The toroidal-shaped surface 12 including the blocks is realized as usual in the tire manufacturing art and as explained, for example, in DE 36 28 042 A1. It comprises, apart from blocks 11 on its surface 12, a smooth surface comprised of a vulcanized rubber compound and below the surface 12 a carcass comprising a reinforcement structure. The cross-like blocks 11 are made of a known vulcanized rubber compound, which is suitable for motorcycle tires. The shaping and vulcanization of the tire 10 is done in a mold. The transition ranges between the toroidal-shaped surface 12 and the cross-like blocks 11 onto this surface 12 and joined to this surface 12 should preferably be made in a rounded manner in order to avoid chunking. Next to this, the outer edges of the blocks 11 preferably also comprise roundings, as this is already described in DE 36 28 042 A1.

In the embodiment of FIG. 1, there are further blocks arranged on the surface of toroidal-shaped surface 12, which have been omitted in the drawing for better lucidity. These further blocks are located preferably on both sides of the circumferentially extending blocks 11, which are situated in the central area 40. They can be arranged and shaped largely arbitrarily. Preferably, the shape of these further blocks is rectangular or quadratic in topview. More preferably, they are either located on both sides of the circumferentially extending blocks 11 next or adjacent to these blocks 11 or circumferentially displaced with regard to these blocks 11.

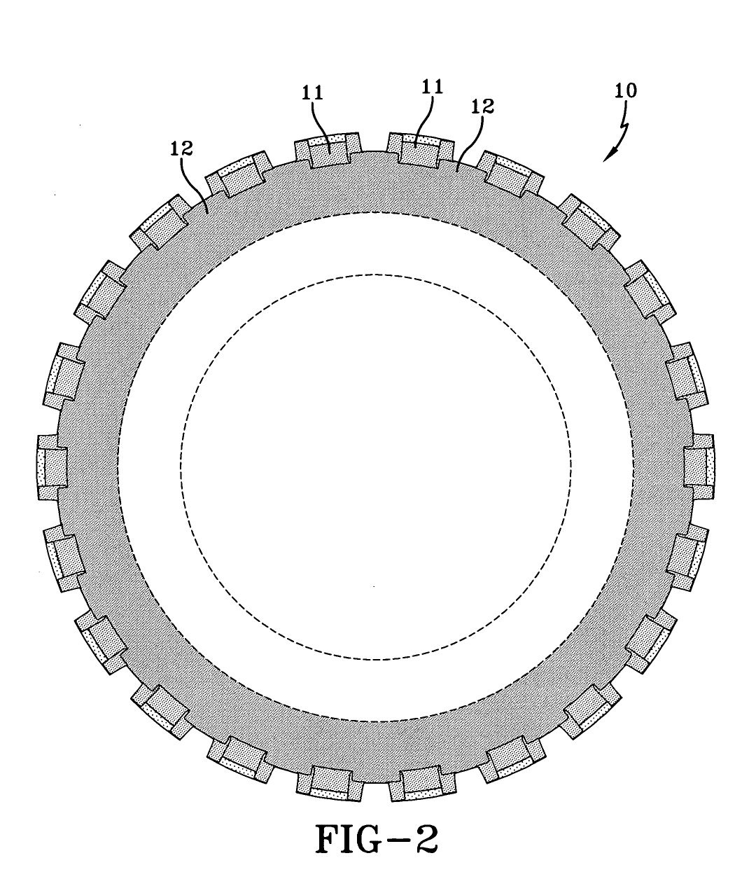

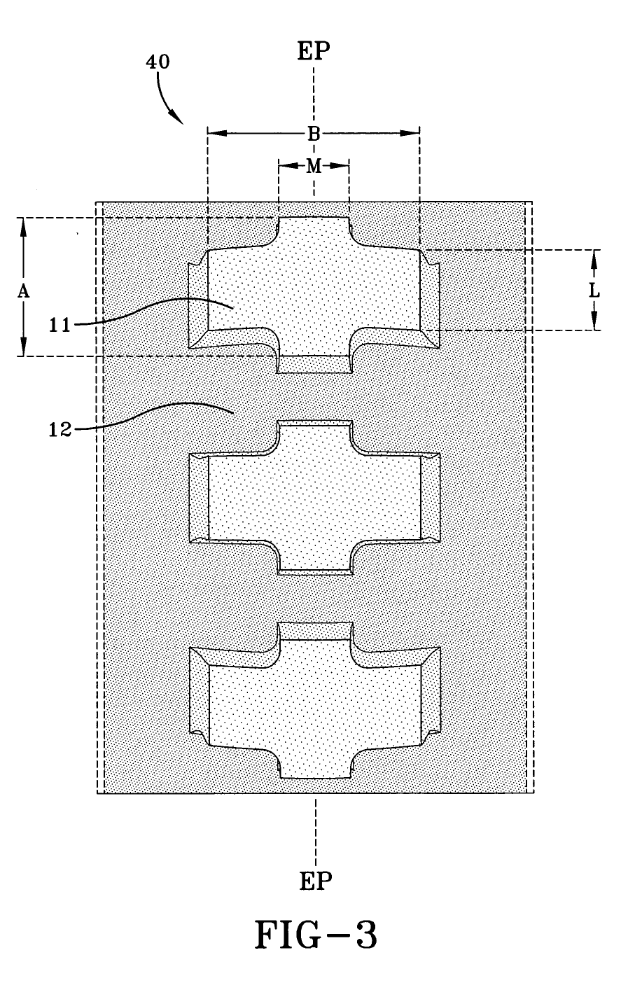

FIG. 2 shows a side-view of the tire of FIG. 1. FIG. 3 explains the shape and dimensioning of the cross-like blocks 11 of FIG. 1. These have a width B of from 40 mm to 90 mm, alternately of from 55 mm to 85 mm, for example 58 mm, a length A of from 25 mm to 50 mm, alternately 32 mm to 44 mm, for example 36 mm, a side length L of the arms of the cross-like structure of from 10 mm to 30 mm, alternately of from 15 mm to 25 mm, for example 20 mm, and a side width M of from 10 mm to 25 mm, alternately of from 15 mm to 20 mm, for example 18 mm. The height of the cross-like blocks 11, which is height the blocks 11 surmount the toroidal-shaped surface 12, is of from 10 mm to 20 mm, alternately of from 14 mm to 18 mm, for example 16 mm. The distance between any point on the surface of the cross-like blocks 11 and an equivalent point on the surface of the surface of an adjacent cross-like block 11 is of from 45 mm to 75 mm, alternately of from 50 mm to 60 mm, for example constantly 54 mm. This distance can vary within these limits from block 11 to block 11 when the tire is revolving, i.e. the blocks 11 need not to be equidistant, but this is preferred. FIG. 3 also shows that the cross-like blocks 11 are arranged in a symmetrical way on a revolving section boundary EP formed by the intersection of the toroidal-shaped surface 12 and the equatorial plane of the tire 10. The equatorial plane is a symmetry plane of the toroidal-shaped surface 12 and oriented perpendicularly to the axle of the motorcycle, i.e. the axis of the rim on which the tire 10 is mounted. The arms of the cross-like structure 11 are oriented perpendicularly to the revolving section boundary EP, i.e. the line A and L are parallel to EP, the lines M and B perpendicular to EP.

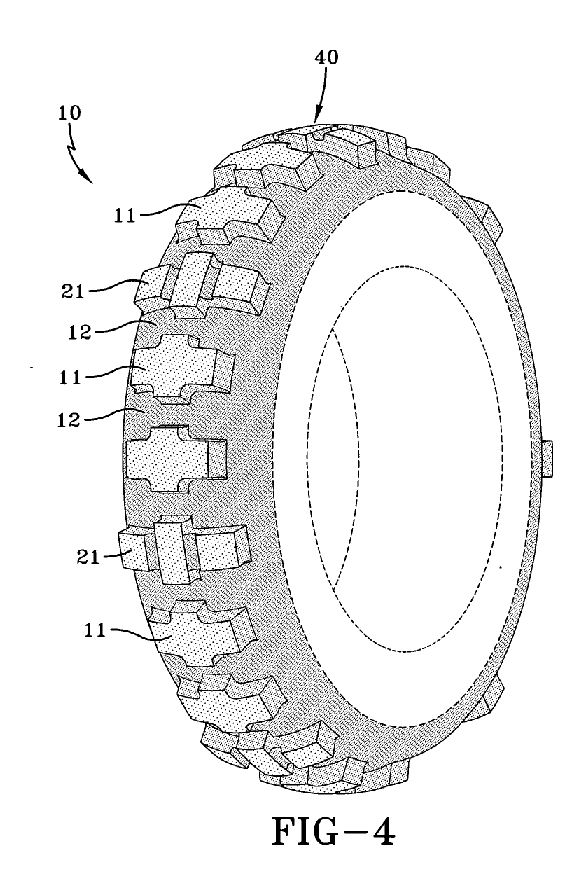

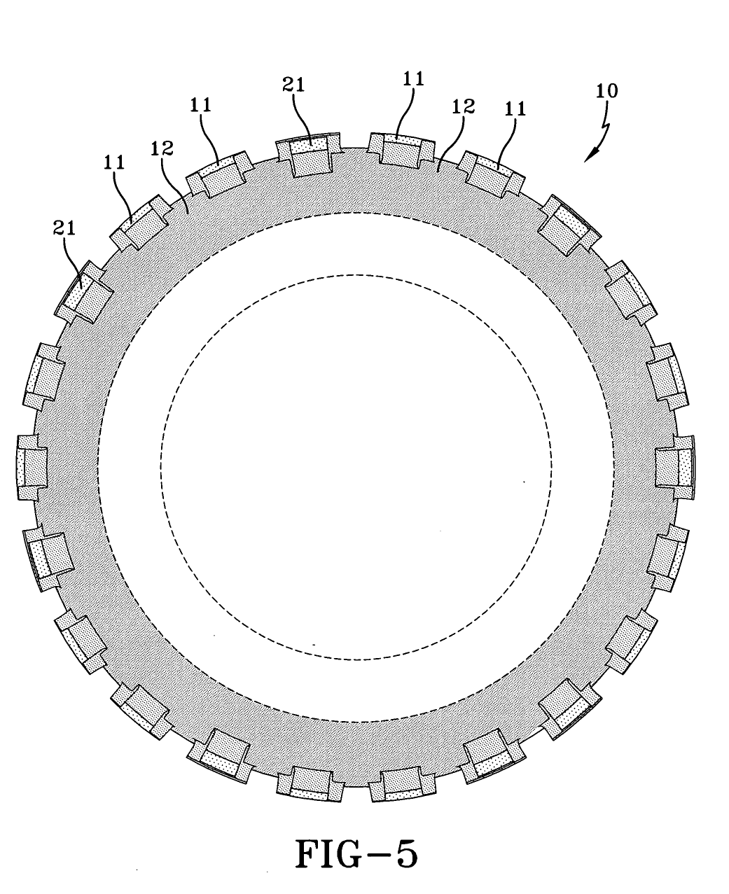

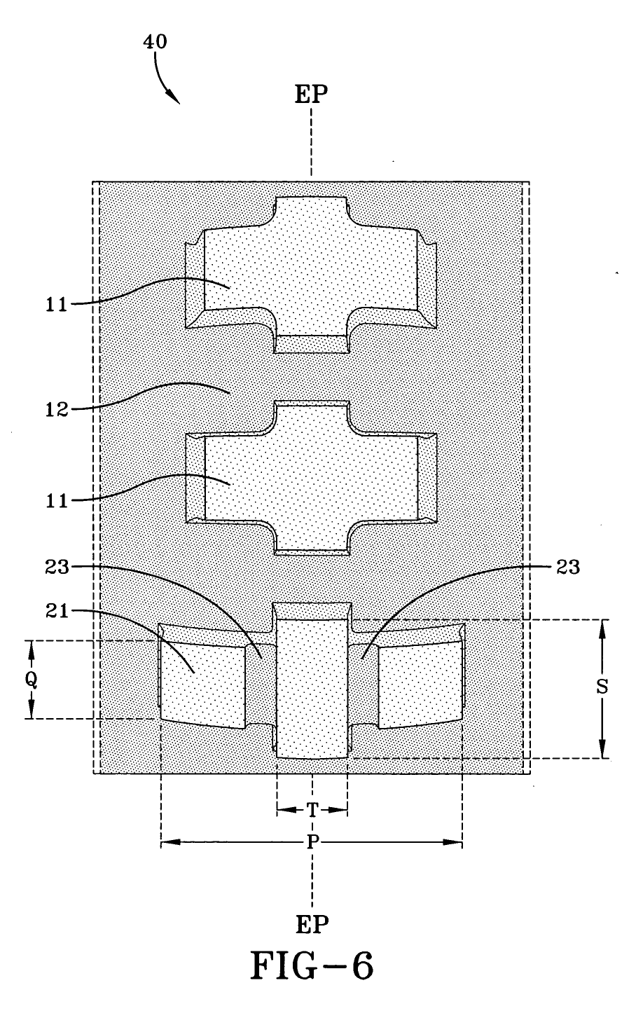

The FIGS. 4, 5 and 6 show a second embodiment of the invention. This embodiment differs from the first embodiment only by the fact that there are now second cross-like blocks 21 in addition to the first cross-like blocks 11 of FIG. 3. Both blocks 11, 21 are located in the central area 40 of the toroidal-shaped surface 12. The second cross-like blocks 21 are explained in more detail by FIG. 6. It can be seen from FIG. 4 or 5 that in the circumferential direction of the tire 10 each second cross-like block 21 is followed by two first cross-like blocks 11. In an alternative but less preferred embodiment, each second cross-like block 21 is always followed by either one or three first cross-like blocks 11.

The second cross-like blocks 21, which are shown in more detail in FIG. 6, have a width P of from 60 mm to 100 mm, alternately of from 75 mm to 90 mm, for example 82 mm, a length S of from 25 mm to 50 mm, alternately 32 mm to 44 mm, for example 36 mm, a side length Q of from 10 mm to 30 mm, alternately of from 15 mm to 25 mm, for example 20 mm, and a side width T of from 10 mm to 25 mm, alternately of from 15 mm to 20 mm, for example 18 mm. The height of the second cross-like blocks 21 corresponds to the height of the first cross-like blocks 11. The distance between any point on the surface of a cross-like blocks 11, 21 and an equivalent point on the surface of an adjacent cross-like block 11, 21 is of from 45 mm to 60 mm, for example constantly 54 mm. The second cross-like blocks 21 also comprise two first grooves 23 at their surface, which are arranged in parallel to and on both side of the section boundary EP formed by the intersection of the toroidal-shaped surface 12 and the equatorial plane of the tire 10. The grooves 23 have a depth of from 3 mm to 9 mm, alternately of from 4 mm to 7 mm, for example 5 mm. The cross section of the grooves 23 is preferably semicircular. The distance between the symmetry axis of the two grooves 23 and the section boundary EP is preferably the same for both grooves 23 and in a range of from 6.5 mm to 16 mm, alternately of from 9 mm to 12 mm, for example 11.5 mm. According to FIG. 6, the lines T and P are oriented perpendicular to the section boundary EP and the lines Q and S are oriented in parallel to the section boundary EP.

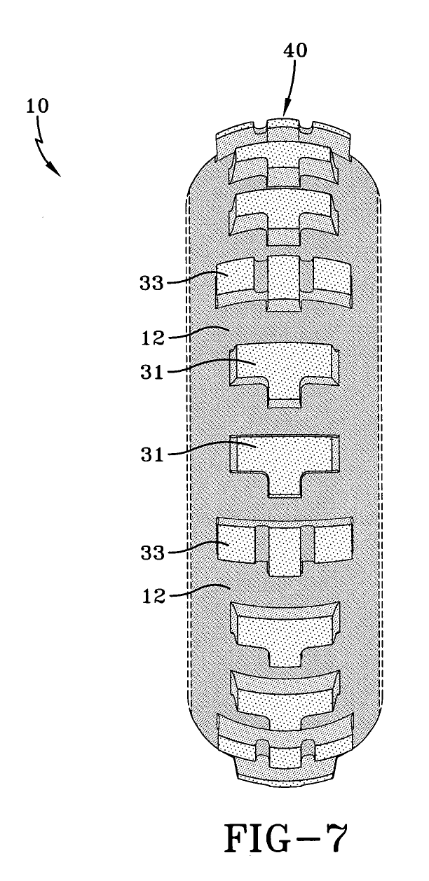

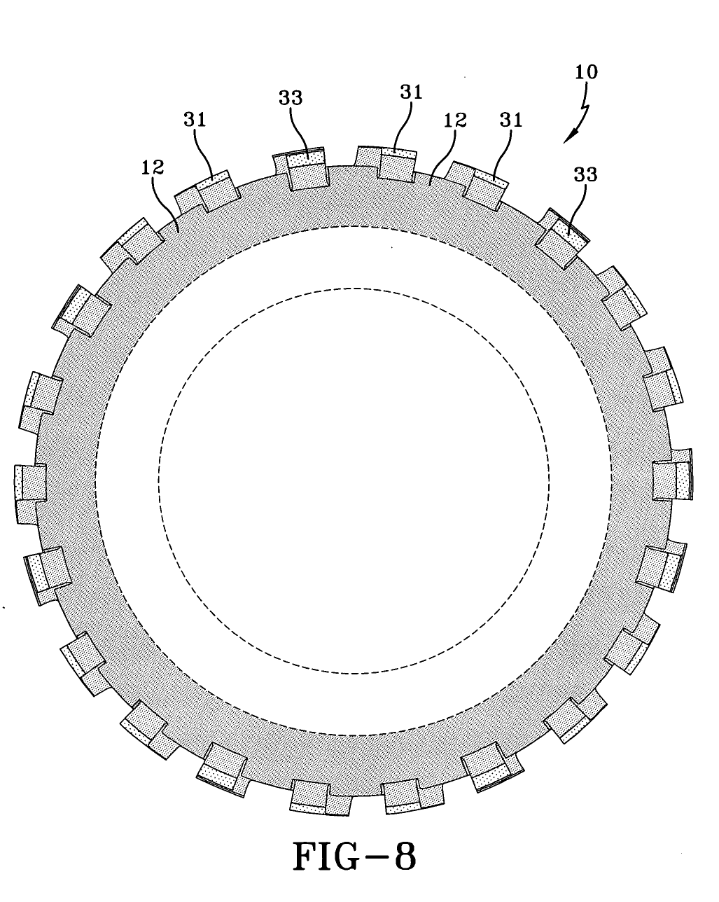

The FIGS. 7, 8 and 9 show a third embodiment of the invention. This embodiment differs from the first or second embodiment according to FIG. 1 or FIG. 4 only by the fact that the first cross-like shaped blocks 11 have been replaced by first T-shaped blocks 31 and second T-shaped blocks 33, which are located in the central area 40 of the toroidal-shaped surface 12. In analogy to the first embodiment, there may be used only first T-shaped blocks 31 or, alternatively, only second T-shaped blocks 33, which are again located in a circumferential manner on toroidal-shaped surface 12. FIG. 7 shows an embodiment where both kinds of T-shaped blocks 31, 33 are used together in a defined sequence in analogy to FIG. 4. The dimensions and the arrangement of the T-shaped blocks 31, 33 according to FIG. 7 are widely the same as the dimensions and the arrangement of the cross-like blocks 11, 21 according to FIG. 4.

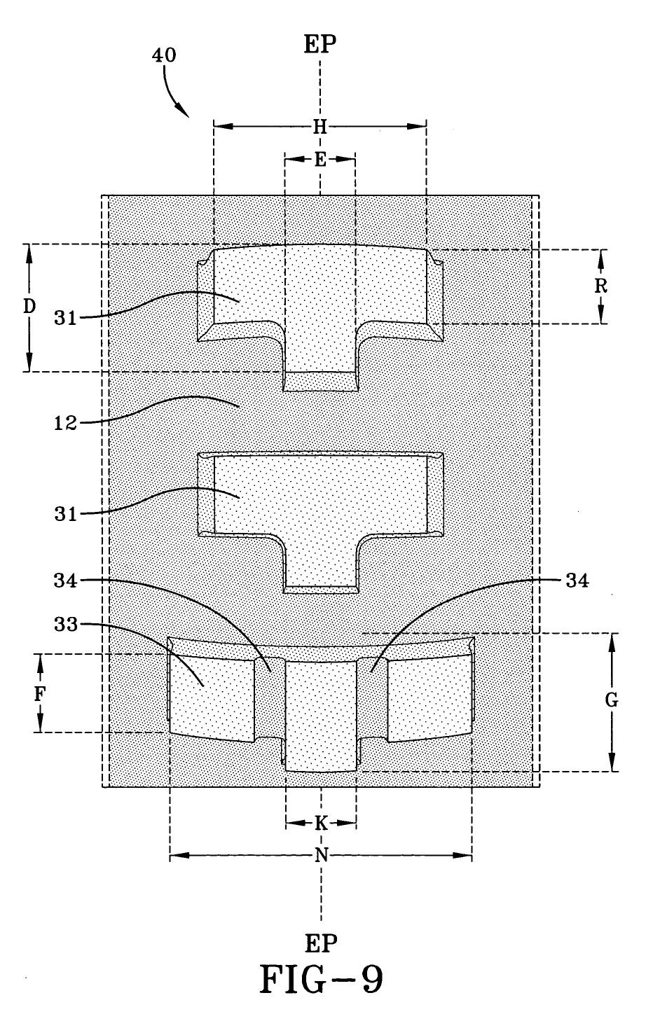

In more detail and as shown in FIG. 9, the first T-shaped blocks 31 have a width H of from 40 mm to 90 mm, alternately of from 55 mm to 85 mm, for example 58 mm, a length D of from 25 mm to 50 mm, alternately 32 mm to 44 mm, for example 40 mm, a side length R of from 10 mm to 30 mm, alternately of from 15 mm to 25 mm, for example 20 mm, and a side width E of from 10 mm to 25 mm, alternately of from 15 mm to 20 mm, for example 18 mm. The height of the first T-shaped blocks 31, which is height which the blocks 31 surmount the toroidal-shaped surface 12, is of from 10 mm to 20 mm, alternately of from 14 mm to 18 mm, for example 16 mm. The distance between any point on the surface of the first T-shaped blocks 31 and an equivalent point on the surface of an adjacent T-shaped block 31, 33 is of from 45 mm to 75 mm, alternately of from 50 mm to 60 mm, for example constantly 54 mm.

The second T-shaped blocks 33 as shown in FIG. 9 have a width N of from 40 mm to 90 mm, alternately of from 75 mm to 90 mm, for example 80 mm, a length G of from 25 mm to 50 mm, alternately 32 mm to 44 mm, for example 40 mm, a side length F of from 10 mm to 30 mm, alternately of from 15 mm to 25 mm, for example 20 mm, and a side width K of from 10 mm to 25 mm, alternately of from 15 mm to 20 mm, for example 18 mm. The height of the second T-shaped blocks 33 corresponds to the height of the first T-shaped blocks 31. The distance between an arbitrary point on the surface of a T-shaped block 31, 33 and an equivalent point on the surface of an adjacent T-shaped block 31, 33 is of from 45 mm to 60 mm, for example 54 mm. As also shown in FIG. 9, the second T-shaped blocks 33 also comprise two second grooves 34 at their surface, which are arranged in parallel to and on both side of the section boundary EP formed by the intersection of the toroidal-shaped surface 12 and the equatorial plane of the tire 10. These second grooves 34 have a depth of from 3 mm to 9 mm, alternately of from 4 mm to 7 mm, for example 5 mm. The cross section of the second grooves 34 is preferably semicircular. The distance between the symmetry axis of the two grooves 34 and the section boundary EP is preferably the same for both grooves 34 and in a range of from 6.5 mm to 16.5 mm, preferably of from 9 mm to 12 mm, for example 11.5 mm.

From FIG. 9, it can be further seen that the T-shaped blocks 31, 33 are arranged in a symmetrical way on the revolving section boundary EP formed by the intersection of the toroidal-shaped surface 12 and the equatorial plane of the tire 10. The lines H, E, K and N in FIG. 9 are oriented perpendicular with regard to the section boundary EP, and the lines D, R, F and G are oriented in parallel to the section boundary EP. Preferably, the T-shaped blocks 31, 33 are oriented in such a way that in the case that the motorcycle is driving forward the shorter edges of the T-shaped blocks 31, 33 having a length E or K always come into contact with the road before the longer edges having a length H or N come into contact with the road.

In a preferred embodiment of the invention, the following respective conditions for the lengths of the lines in FIG. 9 are at least substantially fulfilled:
M=T, S=A, Q=L and P≠B
R=F, E=K, G=D, R=F and H≠N

In all described embodiments, it is generally advantageous if the cross-like or T-shaped blocks 11, 21, 31, 33 comprise at least partially a groove structure on their surface. Such a groove structure can be or comprise the first grooves 23 or the second grooves 34 as explained. The depth of the grooves 23, 34 of the groove structure should be less than the height of the cross-like or T-shaped blocks 11, 21, 31, 33 as measured in a radial direction starting from the toroidal-shaped surface 12. Preferably, the depth of the grooves 23, 34 of the groove structure is of from 20% to 50%, alternately of from 25% to 40%, of this height. Such a groove structure improves driving stability and lateral stability of the motorcycle especially on a sandy ground. Besides this groove structure, the surface of the blocks 11, 21, 31, 33 is preferably at least essentially smooth.

In a further embodiment, the design of the first and second cross-like blocks 11, 21 differs only in the width of the blocks 11, 21 in a direction perpendicular to the section boundary EP and/or in the presence of the groove structure or the first grooves 23. In a still further embodiment, the same applies to the design of the first and the second T-shaped blocks 31, 33, as shown in FIG. 9.

It is obvious for a person skilled in the art that the elucidated embodiments can also be mixed, i.e. next to cross-like blocks 11, 21 (with or without groove structure) there can be also T-shaped blocks 31, 33 (with or without groove structure), wherein the blocks 11, 21, 31, 33 are located in central area 40 of the tire and are arranged in a symmetrical way, and wherein these kinds of blocks 11, 21 or 31, 33 respectively alternate according to given periodic sequence when the tire 10 is revolving. The most preferred embodiment of the invention is shown in FIGS. 4 to 6. It should also be mentioned again that all embodiments comprise further blocks, which are arranged on the surface of toroidal-shaped surface 12, but which have been omitted in the drawing for better lucidity. These further blocks are located on both sides of the circumferentially extending blocks 11, 21, 33, 31, which are situated in the central area 40. These further blocks can be arranged and shaped largely arbitrarily.

Further variations of the present inventions are possible in light of the description of it provided herein. While certain representative embodiments and details have been shown for the purpose of illustrating the subject invention, it will be apparent to those skilled in this art that further various changes and modifications can be made herein without departing from the scope of the subject invention. It is, therefore, to be understood that changes can be made in the particular embodiments described which will be within the full intended scope of the invention as defined by the following appended claims.

1. A motorcycle tire, the tire comprising a generally toroidal-shaped surface extending between two opposite sidewalls of the tire, and a plurality of blocks being arranged onto the toroidal-shaped surface, wherein the blocks are adapted to be ground contacting and to form an outer circumferential tread profile of the tire, characterized in that at least a portion of the blocks has a cross-like structure or a T-shaped structure in topview onto the toroidal-shaped surface.

2. A motorcycle tire according to claim 1, further characterized in that at least a portion of blocks selected from the group consisting of the blocks having the T-shaped structure and the blocks having the cross-like structure is arranged on a section boundary formed by the intersection of the toroidal-shaped surface and the equatorial plane of the tire.

3. A motorcycle tire according to claim 1, further characterized in that at least a portion of blocks selected from the group consisting of the blocks having the T-shaped structure and the blocks having the cross-like structure has a symmetrical structure when viewed in topview onto the toroidal-shaped surface.

4. A motorcycle tire according to claim 1, further characterized in that at least a portion of blocks selected from the group consisting of the blocks having the T-shaped structure and the blocks having the cross-like structure is arranged in a symmetrical way on a section boundary formed by the intersection of the toroidal-shaped surface and the equatorial plane of the tire.

5. A motorcycle tire according to claim 1, further characterized in that the toroidal-shaped surface comprises a central area with a plurality of blocks being arranged within the central area, wherein the central area is circumferentially extending around the toroidal-shaped surface, and wherein
(i) all of the blocks being arranged within the central area are selected from the group consisting of the blocks having the T-shaped structure and the blocks having the cross-like structure, or wherein
(ii) all of the blocks being arranged within the central area are either the blocks having the T-shaped structure or the blocks having the cross-like structure.

6. A motorcycle tire according to claim 1, further characterized in that at least a portion of blocks selected from the group consisting of the blocks having the T-shaped structure and the blocks having the cross-like structure has a groove structure at its surface, wherein the depth of the grooves forming the groove structure is lower than the height of the blocks having the T-shaped or cross-like structure as measured in radial direction starting from the toroidal-shaped surface.

7. A motorcycle tire according to claim 1, further characterized in that at least a portion of blocks selected from the group consisting of the blocks having the T-shaped structure and the blocks having the cross-like structure has a groove structure at its surface, wherein the depth of the grooves forming the groove structure is lower than the height of the blocks having the T-shaped or cross-like structure as measured in radial direction starting from the toroidal-shaped surface, and wherein said grooves are arranged in a symmetrical way with respect to a section boundary formed by the intersection of the toroidal-shaped surface and the equatorial plane of the tire.

8. A motorcycle tire according to claim 1, further characterized in that
(i) a plurality of first blocks with a first cross-like structure and a plurality of second blocks with a second cross-like structure differing from the first cross-like structure are arranged onto the toroidal-shaped surface, wherein said second blocks have at least two grooves at their surface, and wherein said at least two grooves are arranged in parallel to a section boundary formed by the intersection of the toroidal-shaped surface and the equatorial plane of the tire; or in that
(ii) a plurality of first blocks with the first T-shaped structure and a plurality of second blocks with the second T-shaped structure differing from the first T-shaped structure are arranged onto the toroidal-shaped surface, wherein said second blocks have at least two grooves at their surface, and wherein said at least two grooves are arranged in parallel to a section boundary formed by the intersection of the toroidal-shaped surface and the equatorial plane of the tire.

9. A motorcycle tire according to claim 1, further characterized in that at least a portion of blocks selected from the group consisting of the blocks having the T-shaped structure and the blocks having the cross-like structure has an essentially smooth surface.

10. A motorcycle tire according to claim 1, further characterized in that the toroidal-shaped surface comprises a central area with a plurality of blocks being arranged within the central area, wherein the central area is circumferentially extending around the toroidal-shaped surface, wherein all of the blocks arranged within the central area are circumferentially extending, uniformly shaped blocks being arranged on a section boundary formed by the intersection of the toroidal-shaped surface and the equatorial plane of the tire, and wherein all of the blocks are either the blocks having the T-shaped structure or the blocks having the cross-like structure.

11. A motorcycle tire according to claim 1, further characterized in that first blocks with a first cross-like structure and second blocks with a second cross-like structure differing from the first cross-like structure are arranged in a circumferential way on a section boundary formed by the intersection of the toroidal-shaped surface and the equatorial plane of the tire, and that between two sequent blocks of the first blocks in each case at least one, preferably two or three, of the second blocks are arranged.

12. A motorcycle tire according to claim 1, further characterized in that first blocks with a first T-shaped structure and second blocks with a second T-shaped structure differing form the first blocks' structure are provided in a circumferential way on a section boundary formed by the intersection of the toroidal-shaped surface and the equatorial plane of the tire, and that between two sequent blocks of the first blocks in each case at least one, preferably two or three, of the second blocks are arranged.

13. A motorcycle tire according to claim 1, further characterized in that first blocks with a T-shaped structure and second blocks with a cross-like structure are provided in a circumferential way on a section boundary formed by the intersection of the toroidal-shaped surface and the equatorial plane of the tire, and that between two sequent first blocks with the T-shaped structure in each case at least one, preferably two or three, of the second blocks with the cross-like structure are arranged, or that between two sequent second with the cross-like structure in each case at least one, preferably two or three, of the first blocks with the T-shaped structure are arranged.

14. A motorcycle tire according to claim 1, further characterized in that first blocks with a first cross-like structure and second blocks with a second cross-like structure differing form the first blocks' structure are provided in a circumferential way on a section boundary formed by the intersection of the toroidal-shaped surface and the equatorial plane of the tire, wherein the first blocks and the second blocks differ only
(i) in their width perpendicular to the section boundary; or
(ii) in the presence of a groove structure comprising at least one groove on the surface of the respective blocks; or
(iii) in their width perpendicular to the section boundary and in the presence of a groove structure comprising at least one groove at the surface of the respective blocks.

15. A motorcycle tire according to claim 1, further characterized in that first blocks with a first T-shaped structure and second blocks with a second T-shaped structure differing form the first blocks' structure are provided in a circumferential way on a section boundary formed by the intersection of the toroidal-shaped surface and the equatorial plane of the tire, wherein the first blocks and the second blocks differ only
(i) in their width perpendicular to the section boundary; or
(ii) in the presence of a groove structure comprising at least one groove on the surface of the respective blocks; or
(iii) in their width perpendicular to the section boundary and in the presence of a groove structure comprising at least one groove at the surface of the respective blocks.

16. A motorcycle tire according to claim 1, further characterized in that first blocks with a first cross-like structure and second blocks with a second cross-like structure differing form the first blocks' structure are provided, wherein the second blocks comprise at least two grooves at their surface which are arranged in parallel to a section boundary formed by the intersection of the toroidal-shaped surface and the equatorial plane of the tire, and wherein the grooves have a depth of from 3 mm to 9 mm, alternately of from 4 mm to 7 mm.

17. A motorcycle tire according to claim 1, further characterized in that first blocks with a first T-shaped structure and second blocks with a second T-shaped structure differing form the first blocks' structure are provided, wherein the second blocks comprise at least two grooves at their surface which are arranged in parallel to a section boundary formed by the intersection of the toroidal-shaped surface and the equatorial plane of the tire, and wherein the grooves have a depth of from 3 mm to 9 mm, alternately of from 4 mm to 7 mm.

18. A motorcycle tire according to claim 1, further characterized in that at least one of the blocks selected from the group consisting of the blocks having the T-shaped structure and the blocks having the cross-like structure has a height of from 10 mm to 20 mm, alternatively of from 14 mm to 18 mm, as measured in radial direction starting from the toroidal-shaped surface.

19. A motorcycle tire according to claim 1, further characterized in that the blocks selected from the group consisting of the blocks having the T-shaped structure and the blocks having the cross-like structure have a width as measured in perpendicular direction to a section boundary formed by the intersection of the toroidal-shaped surface and the equatorial plane of the tire of from 40 mm to 90 mm, alternatively of from 55 mm to 85 mm, and a length as measured in parallel direction to said section boundary of from 25 mm to 50 mm, alternatively of from 32 mm to 44 mm.

20. A motorcycle tire according to claim 1, further characterized in that the blocks selected from the group consisting of the blocks having the T-shaped structure and the blocks having the cross-like structure have a distance between each other, as measured on the toroidal-shaped surface, of from 45 mm to 75 mm, alternatively of from 50 mm to 60 mm.
